(19) United States
(12) Patent Application Publication
(10) Pub. No.: US 2012/0331278 A1
(43) Pub. Date: Dec. 27, 2012

(54) BRANCH REMOVAL BY DATA SHUFFLING

(76) Inventors: Mauricio Breternitz, Austin, TX (US); Patryk Kaminski, Austin, TX (US); Keith Lowery, Bothell, WA (US)

(21) Appl. No.: 13/167,517

(22) Filed: Jun. 23, 2011

(51) Int. Cl. G06F 9/38

(52) U.S. Cl. 712/236; 712/E09.045

(57) ABSTRACT

A system and method for automatically optimizing parallel execution of multiple work units in a processor by reducing a number of branch instructions. A computing system includes a first processor core with a general-purpose micro-architecture and a second processor core with a same instruction multiple data (SIMD) micro-architecture. A compiler detects and evaluates branches within function calls with one or more records of data used to determine one or more outcomes. Multiple compute sub-kernels are generated, each comprising code from the function corresponding to a unique outcome of the branch. Multiple work units are produced by assigning one or more records of data corresponding to a given outcome of the branch to one of the multiple compute sub-kernels associated with the given outcome. The branch is removed. An operating system scheduler schedules each of the one or more compute sub-kernels to the first processor core or to the second processor core.

### BACKGROUND OF THE INVENTION

1. Field of the Invention

This invention relates to computing systems, and more particularly, to automatically optimizing parallel execution of multiple work units in a processor by reducing a number of control flow transfer instructions.

2. Description of the Relevant Art

The parallelization of tasks is used to increase the throughput of computer systems. To this end, compilers may extract parallelized tasks from program code to execute in parallel on the system hardware. With single-core architecture, a single core may include deep pipelines configured to perform multi-threading. To further increase parallel execution on the hardware, a multi-core architecture may include multiple processor cores. This type of architecture may be referred to as a homogeneous multi-core architecture and may provide higher instruction throughput than single-core architecture. However, particular instructions for a computationally intensive task may consume a disproportionate share of a shared resource, which may in turn delay deallocation of the shared resource. Examples of such specific tasks may include cryptography, video graphics rendering, and garbage collection.

To overcome the performance limitations of conventional general-purpose cores, a computer system may offload specific tasks to special-purpose hardware. This hardware may include a single instruction multiple data (SIMD) parallel architecture, a field-programmable gate array (FPGA), and/or other specialized types of processing cores. When an architecture includes multiple cores of different types it may be referred to as a heterogeneous multi-core architecture. Depending on the scheduling of tasks, this type of architecture may provide higher instruction throughput than a homogeneous multi-core architecture.

The OpenCL® (Open Computing Language) framework supports programming across heterogeneous computing environments and includes a low-level application programming interface (API) for heterogeneous computing. The OpenCL framework (generally referred to herein as “OpenCL”) includes a C-like language. In the OpenCL framework a function call may be referred to as an OpenCL kernel, or simply a “kernel”. A software kernel may be matched with one or more records of data to produce one or more work units of computation. Generally speaking, a SIMD architecture offers good computing performance and cost efficiency when executing such data parallel workloads. However, performance may be greatly reduced if the parallel workload includes irregular, data-dependent branch behavior. A work unit may be data independent from another work unit, but it may have data dependence within itself. A conditional test implemented as a branch instruction may pass for a first work unit, but fail for a second work unit.

During execution of an If-Then-Else construct statement, within each column of a SIMD architecture is one or more execution units configured to execute the “Then” and the “Else” paths. Current practice includes executing each of the available paths and selectively disabling the execution units corresponding to work units that did not choose the current path. The efficiency of parallel execution may be reduced as the second work unit halts execution and waits in an idle state as the first work unit continues with its ongoing execution during a given pipe stage.

### SUMMARY OF EMBODIMENTS OF THE INVENTION

Systems and methods for automatically optimizing parallel execution of multiple work units in a processor by reducing a number of control flow transfer instructions are contemplated.

In one embodiment, a computing system includes a first processor core with a first micro-architecture and a second processor core with a second micro-architecture different from the first micro-architecture. In one embodiment, the first micro-architecture is a general-purpose micro-architecture and the second micro-architecture is a same instruction multiple data (SIMD) micro-architecture. The computing system includes a memory coupled to each of the first and the second processor cores. The memory stores a computer program comprising one or more compute kernels, or function calls. As a compiler traverses the instructions of a given function call, the compiler is configured to identify a control flow transfer instruction, such as a conditional branch. To evaluate the branch, the compiler may utilize one of the first and the second processor cores. One or more records of data may be used to determine one or more outcomes.

Multiple compute sub-kernels may be generated, each comprising code from the function corresponding to a unique outcome of the branch. Multiple work units are produced, each invoked in the compiled computer program by assigning one or more records of data corresponding to a given outcome of the branch to one of the multiple compute sub-kernels associated with the given outcome. The branch may be removed. In one embodiment, the assigning comprises moving said one or more records of data to a same group location in a memory for sequential or stride access. In another embodiment, the assigning comprises remapping access from originally assigned sequential records to said one or more records. A scheduler within an operating system (OS) schedules for execution each of the one or more compute sub-kernels to the first processor core or to the second processor core.

These and other embodiments will be further appreciated upon reference to the following description and drawings.

### BRIEF DESCRIPTION OF THE DRAWINGS

FIG. 1 is a generalized block diagram of one embodiment of an exemplary processing node with a heterogeneous multi-core architecture.

FIG. 2 is a generalized block diagram of one embodiment of source code utilizing compute kernels.

FIG. 3 is a generalized block diagram of one embodiment of source code defining compute kernels with conditional statements.

FIG. 4 is a generalized block diagram of one embodiment of scheduled assignments between hardware resources and compute kernels.

FIG. 5 is a generalized block diagram of one embodiment of a logical layout of micro-architectures for two types of processor cores.

FIG. 6 is a generalized block diagram of one embodiment of a general-purpose pipeline execution flow.

FIG. 7 is a generalized block diagram of one embodiment of a SIMD pipeline execution flow.

FIG. 8 is a generalized block diagram illustrating one embodiment of code transformation by removing control flow transfer functions.

FIG. 9 is another generalized block diagram illustrating one embodiment of code transformation by removing control flow transfer functions.

FIG. 10 is a generalized block diagram illustrating one embodiment of code transformation by removing control flow transfer instructions and generating sub-kernels.

FIG. 11 is a generalized flow diagram illustrating one embodiment of a method for optimizing parallel execution of multiple work units in a processor by utilizing pre-runtime data information.

FIG. 12 is a generalized block diagram illustrating one embodiment of data shuffling in memory.

FIG. 13 is a generalized block diagram illustrating one embodiment of creating an index array for data access.

FIG. 14 is a generalized flow diagram illustrating one embodiment of a method for creating an index array for data access.

FIG. 15 is a generalized block diagram illustrating one embodiment of an algorithm for generation index arrays.

FIG. 16 is a generalized block diagram illustrating one embodiment of source code defining the compute kernels utilizing the index arrays.

FIG. 17 is a generalized block diagram illustrating one embodiment of index array generation for two branches.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

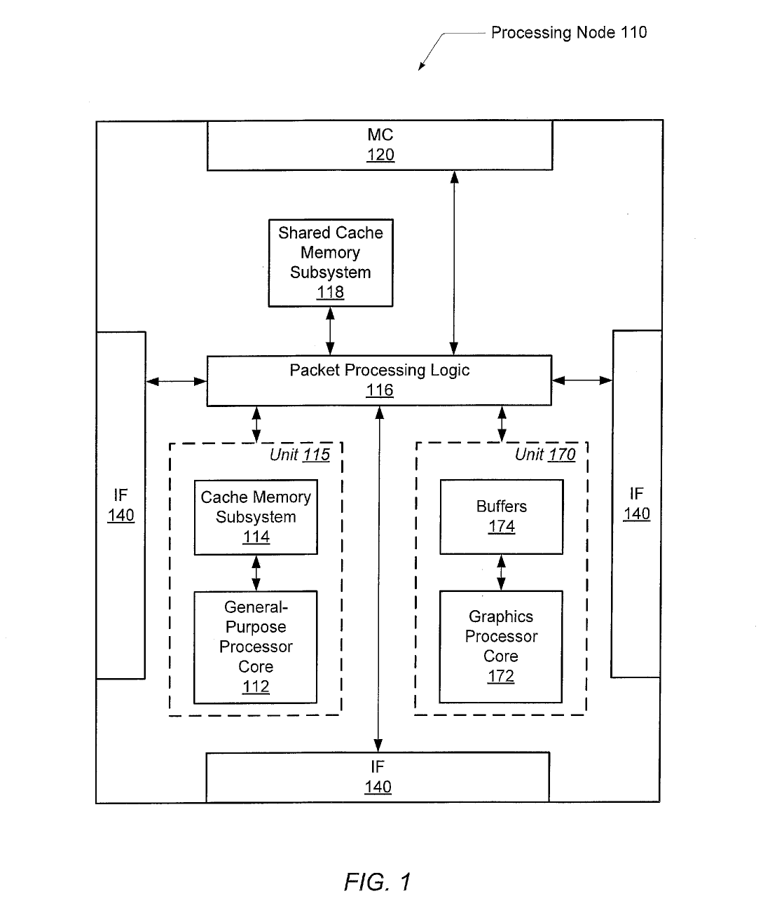

Referring to FIG. 1, one embodiment of an exemplary processing node 110 with a heterogeneous multi-core architecture is shown. Processing node 110 may include one or more processing units 115, which may include one or more processor cores 112 and an associated cache memory subsystem 114. In one embodiment, processor core 112 utilizes a general-purpose micro-architecture.

Processing node 110 may also include one or more processing units 170, which may comprise one or more processor cores 172 and data storage buffers 174. Processor core 172 may not be a mirrored silicon image of processor core 112. Processor core 172 may have a micro-architecture different from the micro-architecture used by processor core 112. In one embodiment, the processor core 172 may be a different generation of a same processor family as processor core 112. In another embodiment, the processor core 172 may be a voltage and/or frequency scaled version of processor core 112. In other words, the processor core 172 is not a silicon copy of the processor core 112 with a same functionality and instruction set architecture (ISA), a same clock frequency, same cache sizes, a same memory model, and so forth.

Continuing with the micro-architecture of processor core 172, in yet another embodiment, the processor core 172 may comprise a micro-architecture that provides high instruction throughput for a computational intensive task. Processor core 172 may have a parallel architecture. For example, the processor core 172 may be a single instruction multiple data (SIMD) core. Examples of SIMD cores include graphics processing units (GPUs), digital signal processing (DSP) cores, or other. In one embodiment, the processing node 110 comprises a single instruction set architecture (ISA). Typically, as is well known in the art, single-ISA multi-core architectures have been shown to provide higher power and throughput performances for chip multiprocessors (CMP).

High instruction throughput on processing node 110 may be achieved with measured power consumption within a given power limit when threads of software applications are efficiently scheduled. The threads may be scheduled on one of processor cores 112 and 172 in a manner that each thread has the highest instruction throughput based at least in part on the runtime hardware resources of the processor cores 112 and 172.

Continuing with the components in the processing node 110, the processing node 110 may include memory controller 120, and interface logic 140. In one embodiment, the illustrated functionality of processing node 110 is incorporated upon a single integrated circuit. In one embodiment, processor cores 112 include circuitry for executing instructions according to a predefined general-purpose instruction set. For example, the SPARC® instruction set architecture (ISA) may be selected. Alternatively, the x86, x86-64®, Alpha®, PowerPC®, MIPS®, PA-RISC®, or any other instruction set architecture may be selected. Generally, processor core 112 accesses the cache memory subsystems 114, respectively, for data and instructions. If the requested block is not found in cache memory subsystem 114 or in shared cache memory subsystem 118, then a read request may be generated and transmitted to the memory controller within the node to which the missing block is mapped.

In one embodiment, processing unit 170 is a graphics processing unit (GPU). Modern GPUs are very efficient at manipulating and displaying computer graphics. The highly parallel structure of GPUs makes them more effective than general-purpose central processing units (CPUs), such as processing unit 115, for a range of complex algorithms. Typically, a GPU executes calculations used for graphics and video and a CPU executes calculations for many more system processes than graphics alone. Conventional GPUs utilize very wide single instruction multiple data (SIMD) architectures to achieve high throughput in image-rendering applications. Such applications generally entail executing the same programs, such as vertex shaders or pixel shaders, on large numbers of objects (vertices or pixels). Since each object is processed independently of other objects, but the same sequence of operations is used, a SIMD architecture provides considerable performance enhancement. GPUs have also been considered for non-graphical calculations.

In one embodiment, the GPU 170 may be located on a video card. In another embodiment, the GPU 170 may be integrated on the motherboard. In yet another embodiment, the illustrated functionality of processing node 110 may be incorporated upon a single integrated circuit. In such an embodiment, the CPU 115 and the GPU 170 may be proprietary cores from different design centers. Also, the GPU 170 may now be able to directly access both local memories 114 and 118 and main memory via memory controller 120 from the processing node 110, rather than perform memory accesses off-chip via interface 140. This embodiment may lower latency for memory accesses for the GPU 170, which may translate into higher performance.

Continuing with the components of processing node 110 in FIG. 1, cache subsystems 114 and 118 may comprise high-speed cache memories configured to store blocks of data. Cache memory subsystems 114 may be integrated within respective processor cores 112. Alternatively, cache memory subsystems 114 may be coupled to processor cores 114 in a backside cache configuration or an inline configuration, as desired. Still further, cache memory subsystems 114 may be implemented as a hierarchy of caches. Caches that are located nearer processor cores 112 (within the hierarchy) may be integrated into processor cores 112, if desired. In one embodiment, cache memory subsystems 114 each represent L2 cache structures, and shared cache subsystem 118 represents an L3 cache structure. Both the cache memory subsystem 114 and the shared cache memory subsystem 118 may include a cache memory coupled to a corresponding cache controller.

Generally, packet processing logic 116 is configured to respond to control packets received on the links to which processing node 110 is coupled, to generate control packets in response to processor cores 112 and/or cache memory subsystems 114, to generate probe commands and response packets in response to transactions selected by memory controller 120 for service, and to route packets for which node 110 is an intermediate node to other nodes through interface logic 140. Interface logic 140 may include logic to receive packets and synchronize the packets to an internal clock used by packet processing logic 116.

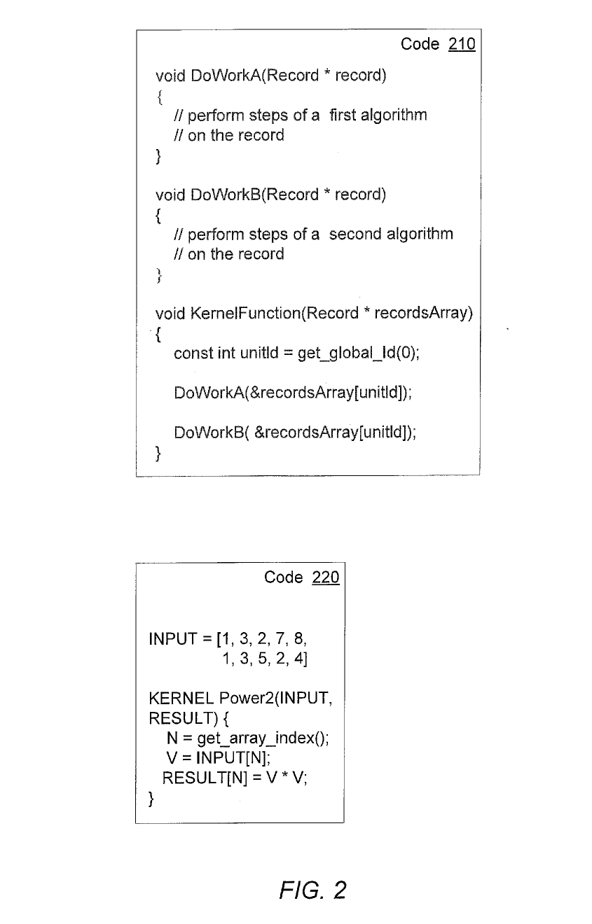

Tuning now to FIG. 2, one embodiment of source code utilizing compute kernels is shown. OpenCL™ (Open Computing Language) is one example of a low-level application programming interface (API) for heterogeneous computing. OpenCL includes a C-like language that defines execution queues, wherein each queue is associated with an OpenCL device. An OpenCL device may be a CPU, a GPU, or other unit with at least one processor core within the heterogeneous multi-core architecture. A function call may be referred to as an OpenCL kernel, or simply a “compute kernel”. The OpenCL framework may improve computing performance for a wide variety of data-parallel applications used in gaming, entertainment, science and medical fields. For a heterogeneous architecture, a computer program typically comprises a collection of compute kernels and internal functions. A software programmer may define the compute kernels, whereas the internal functions may be defined in a given library.

For a data-parallel software application, an N-Dimensional computation domain may define an organization of an “execution domain”. The N-Dimensional computation domain may also be referred to as an N-Dimensional grid or an N-Dimensional Range (“NDRange”). The NDRange may be a one-, two-, or three-dimensional space. This dimensional space may also be referred to as an index space. For example, a software application may perform data processing on a two-dimensional (2D) array of data, such as an image file. The software application may perform an algorithm developed by a software programmer on a pixel-by-pixel basis of a 2D image. A given compute kernel may be invoked over the index space (the NDRange).

Typically after compilation, the arguments and parameters of each compute kernel are set. Additionally, associated memory objects and buffers are created. A given instance of the compute kernel may be executed as its own software thread. However, a compute kernel may include control flow transfer instructions that create forks, whereas a fork in a computer program typically creates a software thread, by common definition. A given instance of the compute kernel at a given point in the index space may be referred to as a work unit or work item. A work unit may operate with the one or more instructions in the compute kernel on a record of data corresponding to a given pixel (a given index) of the 2D image. Typically, work units have an associated unique identifier (ID). In another example, an introductory computer program processing the string “Hello World” may have one work unit for computing each letter in the string.

The NDRange may define a total number of work units that execute in parallel if there is sufficient hardware support. For example, the NDRange may define a number of 280 work units, but a GPU may support the simultaneous execution of 64 work units at any given time. The total number of work units may define a global work size. As is well known to those skilled in the art, the work units may be further grouped into work groups. Each work group may have a unique identifier (ID). The work units within a given work group may be able to communicate with each other and synchronize execution and coordinate memory accesses. A number of work units may be clustered into a wave front for simultaneous execution on a GPU in a SIMD manner. Regarding the example above for 280 total work units, a wave front may include 64 work units.

The OpenCL framework is an open programming standard for various compute devices, or OpenCL devices. A software programmer may avoid writing a vendor-specific code, which may result in improved code portability. Other frameworks are available and may offer more vendor-specific coding for heterogeneous architectures. For example, NVIDIA offers Compute Unified Device Architecture (CUDA®) and AMD offers ATI Stream®. With a CUDA framework, a compute kernel is typically statically compiled when the computer program is compiled. With an OpenCL framework, a compute kernel is typically compiled with a Just-In-Time (JIT) method. The JIT method may generate an appropriate binary code after obtaining the system configuration. With a JIT compilation method, the compilation time is included with the total execution time. Therefore, compiler optimizations may increase the execution time. In addition, at run time the OpenCL compiler generates multiple versions of compute kernels. One version of a compute kernel may be generated for each type of OpenCL device type, such as a general-purpose CPU, a SIMD GPU, and so forth.

The two frameworks, OpenCL and CUDA, have a difference in terminology between their respective execution models. For example, a work unit, a work group, a wave front and an NDRange in OpenCL have corresponding terms in CUDA such as a thread, a thread block, a warp and a grid. Throughout the rest of the description, the terms corresponding to OpenCL are used. However, the systems and methods described may apply to CUDA, ATI Stream and other frameworks.

As shown in FIG. 2, code 210 defines two function calls entitled “doWorkA” and “doWorkB”. Each function call may be referred to as a “compute kernel”. A compute kernel may be matched with one or more records of data to produce one or more computational work units. Therefore, two or more work units may utilize the same instructions of the single function call, but operate on different records of data. For example, the function call “Power2” in code 220 may be used to execute 10 work units, one for each data value in the array “INPUT”. Here, a record comprises a single data value. In other examples, a record may comprise two or more fields, wherein each field includes a data value. A SIMD micro-architecture may efficiently execute the instructions of the kernel “Power2”, calculate the power of 2 for the values in the INPUT array and write the output to the RESULT array.

The OpenCL framework may invoke an instance of a compute kernel multiple times in parallel. Each call to the compute kernel has one associated unique ID (a work unit ID) that may be fetched by calling an internal function named get_global_id(0). Regarding the above example in code 220, the compute kernel “Power2” is invoked once for each data value in the INPUT array. In this case, the compute kernel “Power2” is invoked 10 times. Accordingly, ten unique work unit IDs are fetched. With a JIT compiling method, these instances are invoked at runtime. The OpenCL framework may differentiate between these different instances by utilizing the unique work unit IDs. The data to be operated on (a record) may also be specified, such as a specific data value in the INPUT array. Therefore, at runtime, a work unit may be scheduled by default to a same OpenCL device as the associated compute kernel is scheduled.

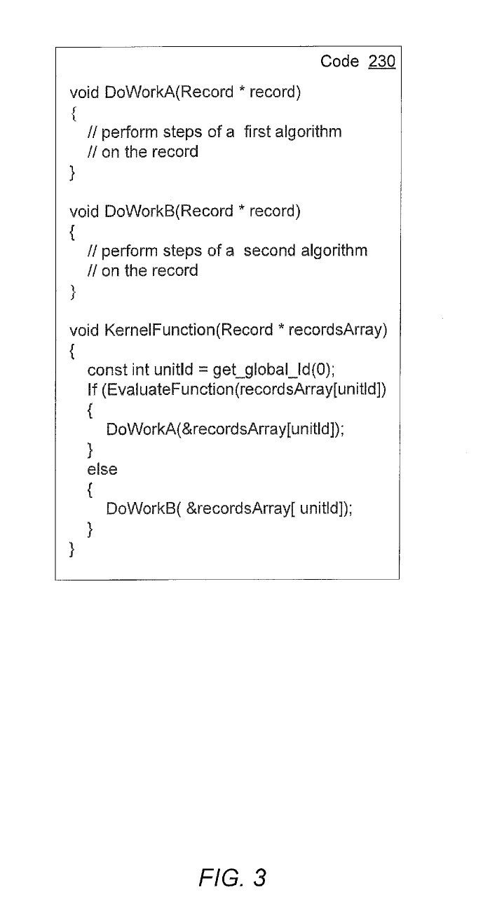

Tuning now to FIG. 3, one embodiment of source code defining compute kernels with conditional statements is shown. Similar to code 210, the code 230 shown in FIG. 3 defines two function calls entitled “doWorkA” and “doWorkB”. Again, each function call may be referred to as a “compute kernel”. Here, only one of the two compute kernels may be executed during runtime. The selection of which compute kernel is executed is based on a conditional test provided by the function call “EvaluateFunction”. A result of a given instruction or whether the given instruction is executed is data-dependent on the execution of previous instructions and data corresponding to an associated record. If the result of the conditional test is not consistent among a wave front of work units, the benefits of a SIMD micro-architecture may be reduced. For example, a given SIMD core may have 64 parallel computation units available for simultaneous execution of 64 work units. However, if half of the 64 work units pass the conditional test while the other half fails the conditional test, then only half of the parallel computation units are utilized during a given stage of processing.

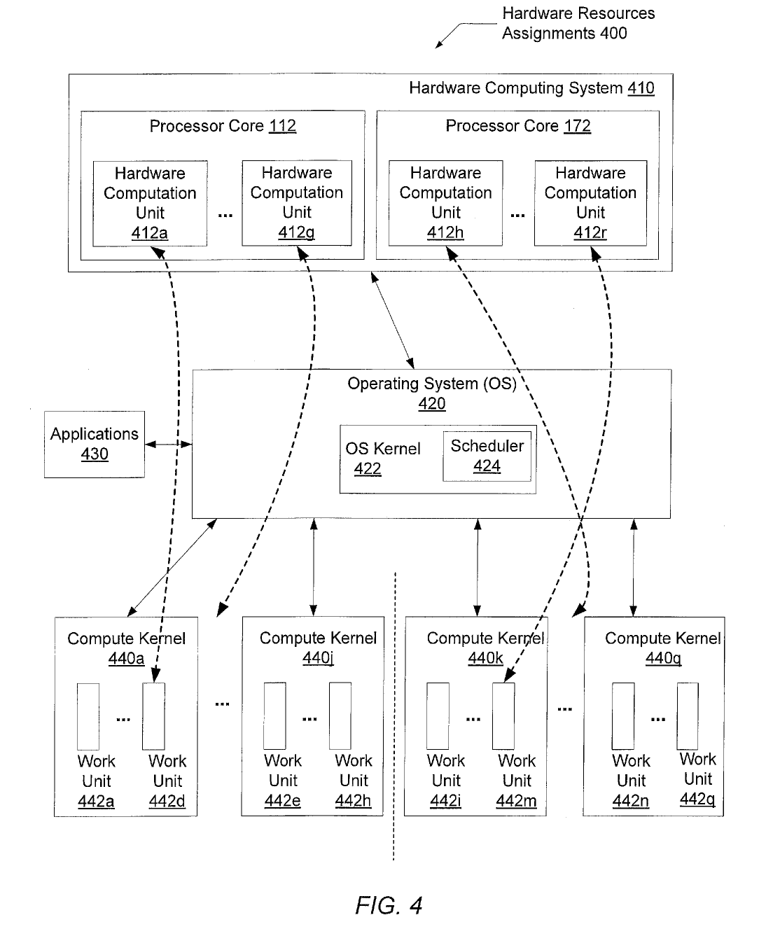

Turning now to FIG. 4, a generalized block diagram illustrating one embodiment of scheduled assignments 400 between hardware resources and compute kernels is shown. Here, the partitioning of hardware and software resources and their interrelationships and assignments during the execution of one or more software applications 430 is shown. In one embodiment, an operating system 420 allocates regions of memory for compute kernels 440a-440j and 440k-440q. When applications 430, or computer programs, execute, each application may comprise multiple compute kernels. For example, a first executing application may comprise compute kernels 440a-440j and a second executing application may comprise compute kernels 440k-440q. Each one of the kernels 440a-440q may be used to generate one or more work units by being combined with one or more records of data (not shown). For example, compute kernel 440a may produce work units 442a-442d, compute kernel 440j may produce work units 442e-442h, compute kernel 440k may produce work units 442j-442m and compute kernel 440q may produce work units 442n-442q. A work unit may execute independently of other work units and execute concurrently with other work units.

Each of the compute kernels shown in FIG. 4 may own its own resources such as an image of memory, or an instance of instructions and data before application execution. Each of the compute kernels may also comprise process-specific information such as address space that addresses the code, data, and possibly a heap and a stack; variables in data and control registers such as stack pointers, general and floating-point registers, program counter, and otherwise; and operating system descriptors such as stdin, stdout, and otherwise, and security attributes such as a set of permissions.

In one embodiment, hardware computing system 410 incorporates a general-purpose processor core 112 and a SIMD processor core 172, each configured to process one or more work units. In another embodiment, system 410 includes two other heterogeneous processor cores. In general, for a given application, operating system 420 sets up an address space for the application, loads the application's code into memory, sets up a stack for the program, branches to a given location inside the application, and begins execution of the application. Typically, the portion of the operating system 420 that manages such activities is the operating system (OS) compute kernel 422. The OS compute kernel 422 is referred to as “OS compute kernel” in order not to confuse it with a compute kernel, or a function call. The OS Compute kernel 422 may further determine a course of action when insufficient memory is available for the execution of the application. As stated before, an application may be divided into more than one compute kernel and system 410 may be running more than one application. Therefore, there may be several compute kernels running in parallel. The OS Compute kernel 422 may decide at any time which of the simultaneous executing compute kernels is allocated to the processor cores 112 and 172. The OS Compute kernel 422 may allow a process to run on a core of a processor, which may have one or more cores, for a given amount of time referred to as a time slice. An OS scheduler 424 in the operating system 420 may comprise decision logic for assigning compute kernels to cores.

In one embodiment, only one compute kernel can execute at any time on any one of the hardware computation units 412a-412g and 412h-412r. These hardware computation units comprise hardware that can handle the execution of a given instruction of a given work unit with associated data. This hardware may include an arithmetic logic unit that is configured to perform addition, multiplication, zero detect, a bit-wise shift, division, video graphics and multimedia instructions or other operations known to those skilled in the art of processor design. These hardware computation units may include a hardware thread in a multi-threaded processor, a parallel hardware column in a SIMD micro-architecture, and so forth.

The dashed lines in FIG. 4 denote assignments and do not necessarily denote direct physical connections. Thus, for example, hardware computation unit 412a may be assigned to execute work unit 442d. However, later (e.g., after a context switch), the hardware computation unit 412a may be assigned to execute work unit 442h. In one embodiment, the OS scheduler 424 may schedule the work units 442a-442q to the hardware computation units 412a-412r with a round-robin scheme. Alternatively, the OS scheduler 424 may schedule the work units 442a-442q to the cores 112 and 172 with a round-robin scheme. An assignment of a given work unit to a given hardware computation unit may be performed by an associated processor core. In another embodiment, the OS scheduler 424 may perform the scheduling based on availability of the processor cores 112 and 172. In yet another embodiment, the OS scheduler 424 may perform the scheduling according to assignments created by a programmer utilizing the OpenCL™ API or another similar API. These scheduling schemes may restrict portability and performance when there is a mismatch between the work unit assignments and hardware resources.

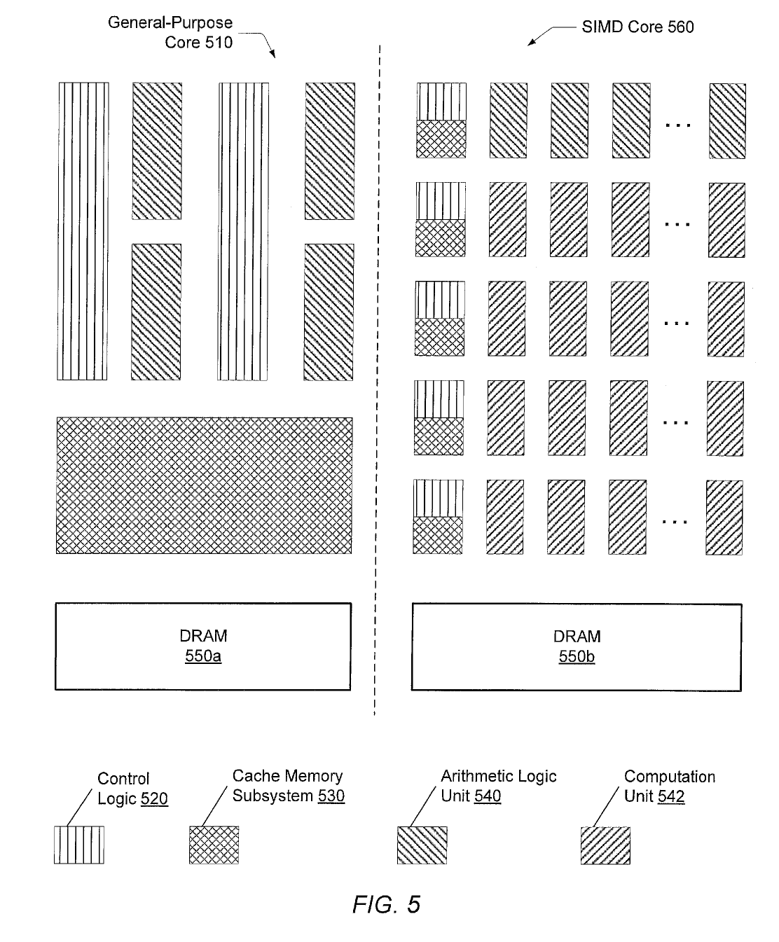

Referring to FIG. 5, a generalized block diagram illustrating one embodiment of a logical layout of micro-architectures for two types of processor cores is shown. Although each of a general-purpose core 510 and a single instruction multiple data (SIMD) core 560 is shown, other types of heterogeneous cores are possible and contemplated. Each of the cores 510 and 560 have a dynamic random access memory (DRAM) 550a and 550b for storage of data and instructions. In one embodiment, the cores 510 and 560 share a same DRAM. In another embodiment, a given level of a cache memory subsystem (not shown) is shared in addition to the DRAM. For example, referring again to FIG. 1, the cache memory subsystem 118 is shared by the cores 112 and 172.

Each of the cores 510 and 560 include a cache memory subsystem 530. As shown, the general-purpose core 510 logically has the cache memory subsystem 530 separate from the control logic 520 and the arithmetic logic units (ALUs) 540. The data flow within the core 510 may be pipelined, although storage elements, such as pipeline registers, are not shown in order to simplify the illustration. In a given pipeline stage, an ALU may be unused if instructions in this stage do not utilize a certain type of ALU or if another work unit (or another thread for a general-purpose core) consumes the ALUs during this stage.

As shown, the SIMD core 560 has the cache memory subsystem 530 grouped with control logic 520 for each row of computation units 542. The data flow within the core 560 may be pipelined, although storage elements, such as pipeline registers, are not shown in order to simplify the illustration. In a given pipeline stage, a computation unit may be unused if an associated instruction in this stage is not executed based on a previous failed test, such as a not-taken branch.

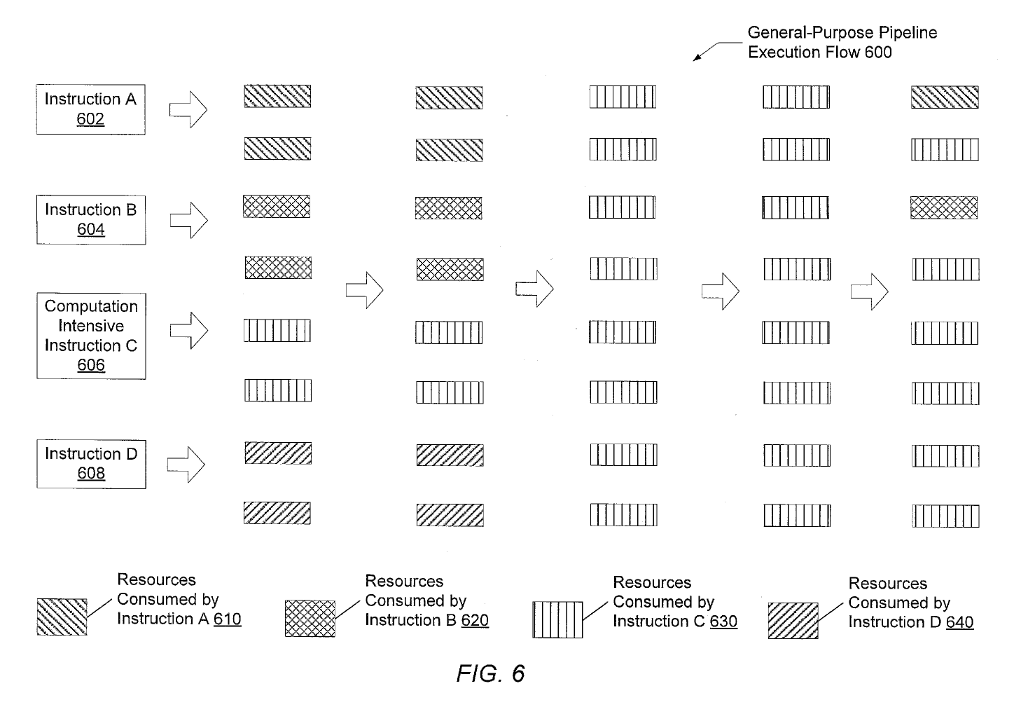

Referring now to FIG. 6, a generalized block diagram illustrating one embodiment of a general-purpose pipeline execution flow 600 is shown. Instructions 602-608 may be fetched and enter a general-purpose pipeline. Instruction 606 may be a computation intensive instruction. During particular stages of the pipeline execution flow, one or more of the instructions 602-608 consume resources in the general-purpose processor core 112, such as decoder logic, instruction scheduler entries, reorder buffer entries, ALUs, register file entries, branch prediction units, and so forth.

In a balanced scheme, each of the instructions 602-608 consume an equal amount of resources each stage. However, typically, a general-purpose core does not replicate resources for each instruction due to real-estate cost, power consumption and other design considerations. Therefore, the workload may become unbalanced. For example, the instruction 606 may consume more resources for one or more pipe stages due to its computation intensive behavior. As shown, the resources 630 consumed by this instruction may become far greater than the resources consumed by other instructions. In fact, the computation intensive instruction may block the usage of hardware resources by other instructions.

Some computation intensive tasks may place pressure on shared resources within the general-purpose core 112. Thus, throughput losses occur for both the computational intensive process and other processes waiting for the shared resources. In addition, some instructions occupy the shared resource and other resources on the die to support the computation being performed on the shared resource. Such a long latency instruction may concurrently block other processes from using several resources during a long latency.

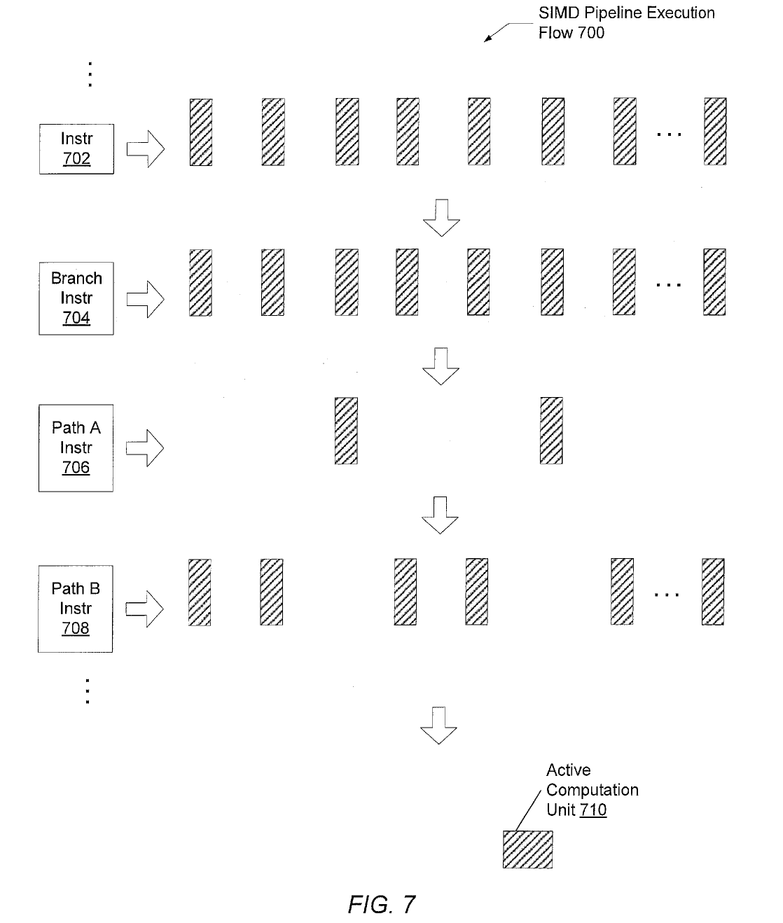

Referring now to FIG. 7, a generalized block diagram illustrating one embodiment of a SIMD pipeline execution flow 700 is shown. Instructions 702-708 may be fetched and enter a SIMD pipeline with associated data. Instruction 704 may be a control flow transfer instruction, such as a branch. The instruction 706 may be a first instruction in a taken path. For example, the branch instruction 704 may be associated with an IF statement in a high-level language program. The instruction 706 may be associated with a THEN statement in the high-level language program. The instruction 708 may be a first instruction in a not-taken path. The instruction 708 may be associated with an ELSE statement in the high-level language program.

Each of the computation units within a given row may be a same computation unit. Each of these computation units may operate on a same instruction, but different data associated with a different work unit. As shown, some of the work units pass the test provided by the branch instruction 704 and other work units fail the test. The SIMD core 172 may execute each of the available paths and selectively disable the execution units, such as the computation units, corresponding to work units that did not choose the current path. For example, during execution of an If-Then-Else construct statement, within each column of a SIMD architecture are execution units configured to execute the “Then” (Path A) and the “Else” (Path B) paths. The efficiency of parallel execution may be reduced as the first and the second work units halt execution and wait as the third work unit continues with its ongoing execution. Therefore, not all of the computation units are active computation units 710 in a given row after execution of the branch instruction 704. If a large number of computation units are inactive during a given pipe stage, the efficiency and throughput of the SIMD core is reduced.

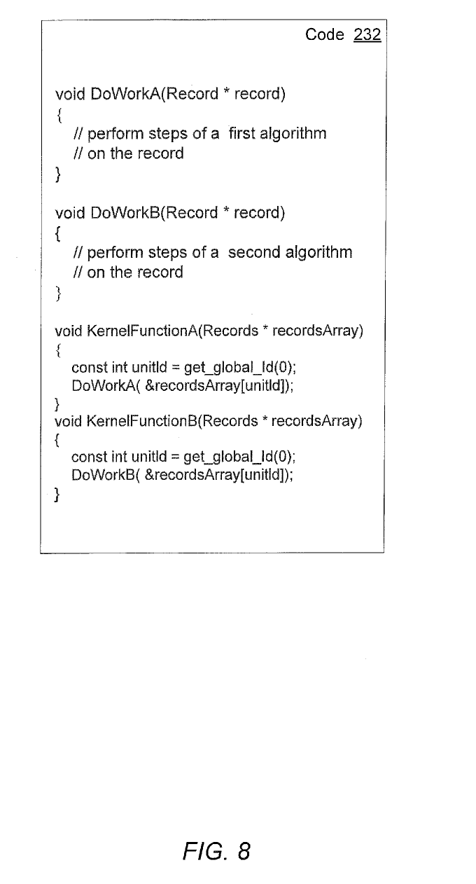

Referring now to FIG. 8, a generalized block diagram illustrating one embodiment of code transformation by removing control flow transfer functions is shown. Similar to code 210 and code 230 shown in FIG. 2 and FIG. 3, the code 232 defines two function calls entitled “doWorkA” and “doWorkB”. Again, each function call may be referred to as a “compute kernel”. In the example shown, the code 230 has been transformed into the code 232, wherein the conditional IF statement with a function “EvaluateFunction” has been removed.

Only one of the two compute kernels in code 232 is executed during runtime for a given group of records. For example, the conditional IF statement may evaluate to “true” if a given record has an even data value. Similarly, the conditional IF statement may evaluate to “false” if a given record has an odd data value. For a given array with data values 1 to 10, the even records {2, 4, 6, 8, 10} may evaluate to true and the function doWorkA is executed. The odd records {1, 3, 5, 7, 9} may evaluate to false and the function doWorkB is executed. After the code transformation from code 230 to code 232, scheduling may include combining the function “KernelFunctionA” with the even records {2, 4, 6, 8, 10} to generate five work units. Similarly, scheduling may include combining the function “KernelFunctionB” with the odd records {1, 3, 5, 7, 9} to generate five additional work units. In one embodiment, the combining of the compute kernel code with a record of data may be performed by shuffling, or rearranging, the records in memory into groups. In another embodiment, this combination may be performed by creating an index array that maps sequential or stride indices to scattered actual locations in memory. Further details of both embodiments are provided later below.

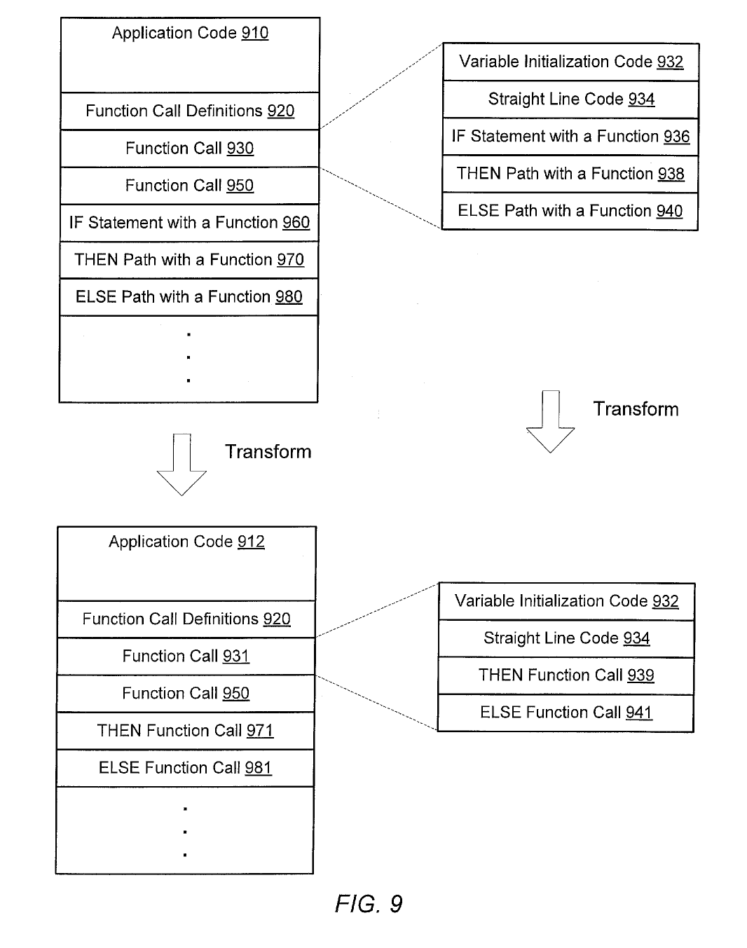

Referring now to FIG. 9, another generalized block diagram illustrating one embodiment of code transformation by removing control flow transfer instructions is shown. The transformation shown is a generalization of the transformation between code 230 and code 232. Application code 910 comprises at least function call definitions 920, functions 930-950, an IF statement 960 with a function, a THEN Path 970 with a function and an ELSE Path 980 with a function. As shown, the function call 930 includes variable initialization code 932, straight-line code 934, and an IF statement 936 with a function, a THEN Path 938 with a function and an ELSE Path 940 with a function. The components shown for application code 910 are for illustrative purposes. Other components may be included or arranged in a different order.

After transformation, the application code 912 may include the components used in the application code 910, but without the conditional IF statements 960 and 936. In addition, each of the THEN Paths 970 and 938 and the ELSE Paths 980 and 940 may be altered to include a surrounding function call that inputs the proper records. A similar transformation is shown in code 232. Again, the combining of the compute kernel code with a record of data may be performed by shuffling, or rearranging, the records in memory into groups. Alternatively, this combination may be performed by creating an index array that maps sequential or stride indices to scattered actual locations in memory.

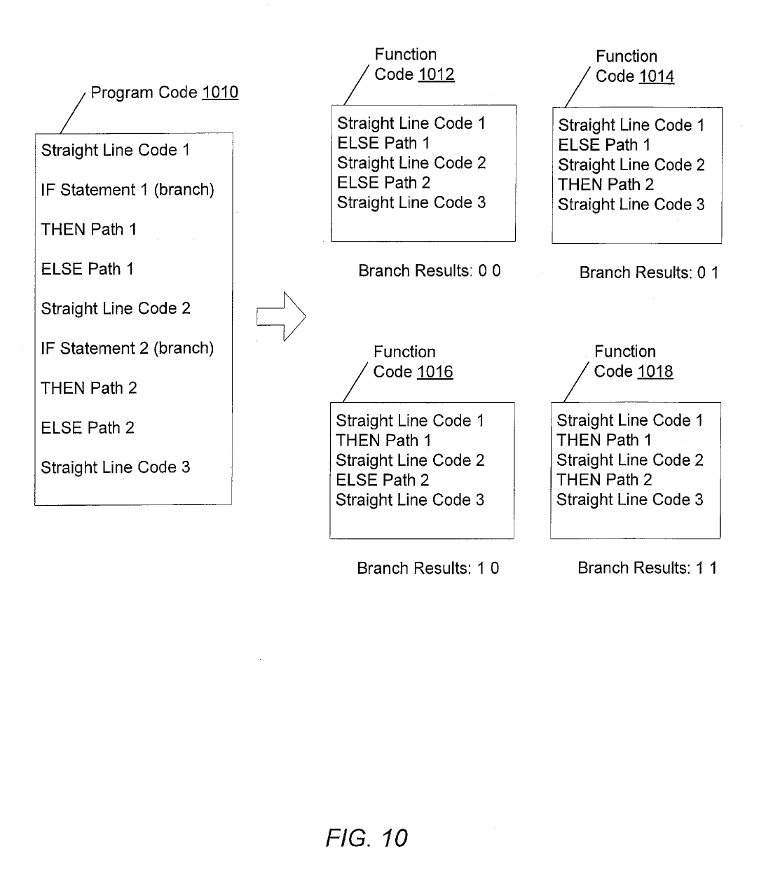

Turning now to FIG. 10, a generalized block diagram illustrating one embodiment of code transformation by removing control flow transfer instructions and generating sub-kernels is shown. Program code 1010 has two IF statements. The transformations for the four possible outcomes of the IF statements and the resulting function code is shown to the right. The transformations remove conditional statements and are performed in a manner as shown in the above descriptions. For example, Function code 1012 shows a result of a transformation of program code 1010 for a given record of data that causes both branches to fail. Function code 1014 shows a result of a transformation of program code 1010 for a given record of data that causes the first branch to fail and the second branch to pass. Function code 1016 and 1018 show results of transformations for records of data that cause the remaining two possible results.

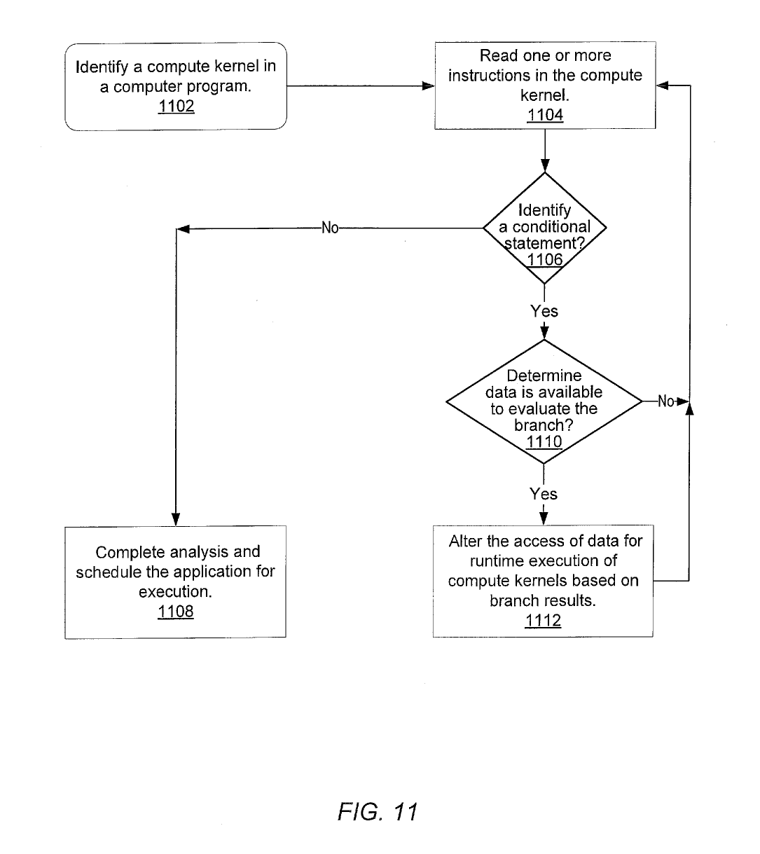

Turning now to FIG. 11, one embodiment of a method 1100 for optimizing parallel execution of multiple work units in a processor by utilizing pre-runtime data information is shown. The components embodied in the processing node 110 and the hardware resource assignments shown in FIG. 4 described above may generally operate in accordance with method 1100. For purposes of discussion, the steps in this embodiment and subsequent embodiments of methods described later are shown in sequential order. However, some steps may occur in a different order than shown, some steps may be performed concurrently, some steps may be combined with other steps, and some steps may be absent in another embodiment.

In block 1102, a software program or subroutine may be located and analyzed. This software program may be written for compilation and execution on a heterogeneous multi-core architecture. Program code may refer to any portion of a software application, subroutine, dynamic linked library, or otherwise. A pathname may be entered at a command prompt by a user, a pathname may be read from a given directory location, or elsewhere, in order to begin compiling the source code. The program code may be written by a designer in a high-level language such as C, a C-like language such as OpenCL™, and so forth. In one embodiment, the source code is statically compiled. In such an embodiment, during a static front-end compilation, the source code may be translated to an intermediate representation (IR). A back-end compilation step may translate the IR to machine code. The static back-end compilation may perform various transformations and optimizations. In another embodiment, the source code is compiled with a Just-In-Time (JIT) method. The JIT method may generate an appropriate binary code after obtaining the system configuration. With either method, the compiler may identify a compute kernel in the program code.

In block 1104, the compiler may read one or more instructions of the compute kernel and analyze them. A conditional statement may be a control flow transfer instruction, such as a branch. Different types of control flow transfer instructions may include forward/backward branches, direct/indirect branches, jumps, and so forth. It may be possible for a compiler or other tool to statically determine a direction of a branch and/or a target of a branch. However, in one embodiment, some processing typically performed during runtime on associated data may be performed during compilation. For example, a simple test to determine a direction (taken, not-taken) of a branch may be performed. Although, compilation may be referred to as “static compilation”, one or more dynamic operations may be performed. This compilation may also be referred to as “pre-runtime compilation”. Another example of a dynamic step performed at this time is identifying a next instruction to execute in each of a THEN, ELSE IF and ELSE blocks of an If-Then-ElseIf-Else construct.

If a conditional statement is not identified (conditional block 1106), then in block 1110, any remaining analysis and instrumentation is completed and work units are scheduled for runtime execution. If a conditional statement is identified (conditional block 1106), and data is available for pre-runtime evaluation (conditional block 1112), then in block 1114, the access of data for runtime execution of compute kernels is altered based on the branch results. For example, the combining of the compute kernel code with a record of data may be performed by shuffling, or rearranging, the records in memory into groups. Alternatively, this combination may be performed by creating an index array that maps sequential or stride indices to scattered actual locations in memory.

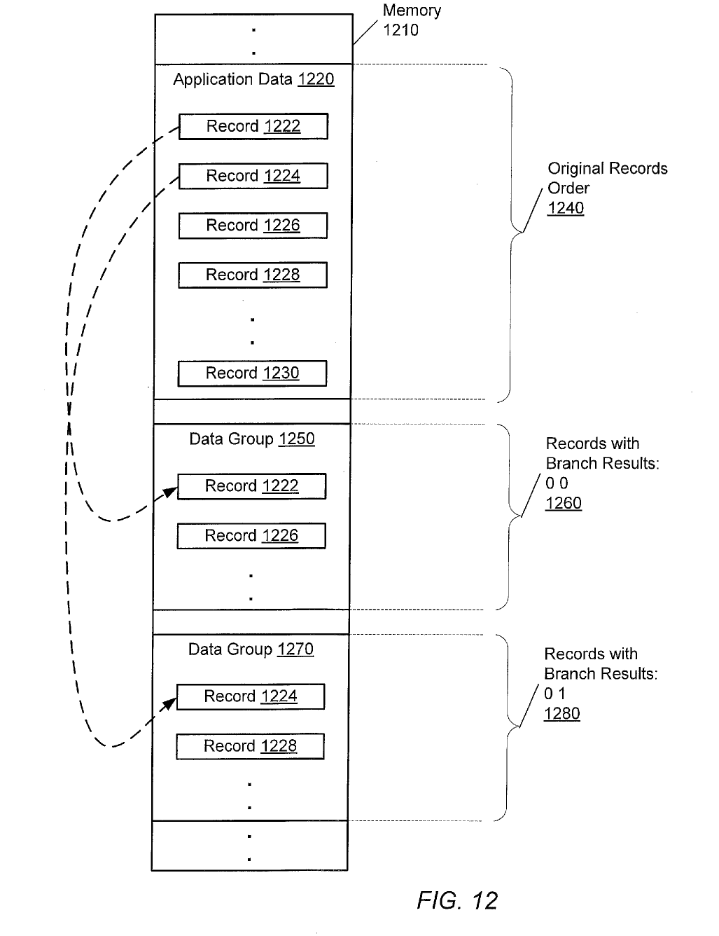

Turning now to FIG. 12, a generalized block diagram illustrating one embodiment of data shuffling in memory is shown. Memory 1210 may be main memory such as DRAM. In addition, the contents stored in Memory 1210 may be stored in one or more levels of a cache memory subsystem. The application data 1220 may store records of data for a given software application, wherein each record may include one or more fields comprising data values. As shown, application data 1220 may include records 1222-1230.

The original records order 1240 may not yield optimal parallel execution of multiple work units generated from compute kernels. Therefore, as described in block 1112 of method 1100, the code for compute kernels may be analyzed. Given instructions may be evaluated with associated records of data. Based on the results, the records may be rearranged in memory to provide optimal parallel execution of the generated work units. In one embodiment, within a given group of records, each associated work unit may return a same result for one or more conditional instructions like a branch.

The records 1222 and 1226 may provide the same results for two branches in the example shown. Here, each of records 1222 and 1226 may fail each of the two branches, as do other records in the arrangement 1260. Therefore, each of records 1222 and 1226 may be moved to data group 1250. Similarly, each of records 1224 and 1228 may fail a first branch and pass a second branch, as do other records in the arrangement 1280. Therefore, each of records 1224 and 1228 may be moved to data group 1270.

The work units associated with data group 1250 may be scheduled together for execution. The work units associated with data group 1270 may be scheduled together for execution after the work units associated with data group 1250. In a simple example, originally record 1222 may have been associated with a work unit ID 0, record 1224 may have been associated with a work unit ID 1, record 1226 may have been associated with a work unit ID 2, and so forth. However, after the data shuffling, the record 1222 may still be associated with a work unit ID 0, but record 1226 may be associated with a work unit ID 1. A record (not shown) following record 1226 in data group 1250 may be associated with a work unit ID 2, and so forth. The record 1224 may be associated with a work unit ID following a work unit ID for a last record in data group 1250. Referring again to FIG. 8, the code in the compute kernel “KernelFunctionA” may be executed on the records in data group 1250. The code in the compute kernel “KernelFunctionB” may be executed on the records in data group 1270.

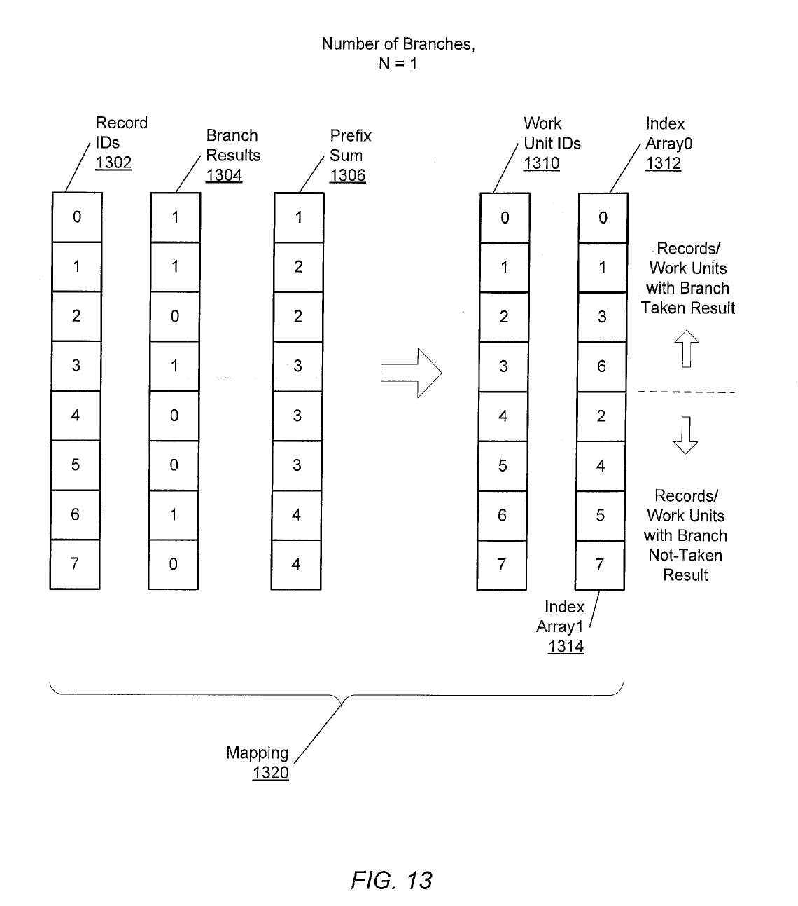

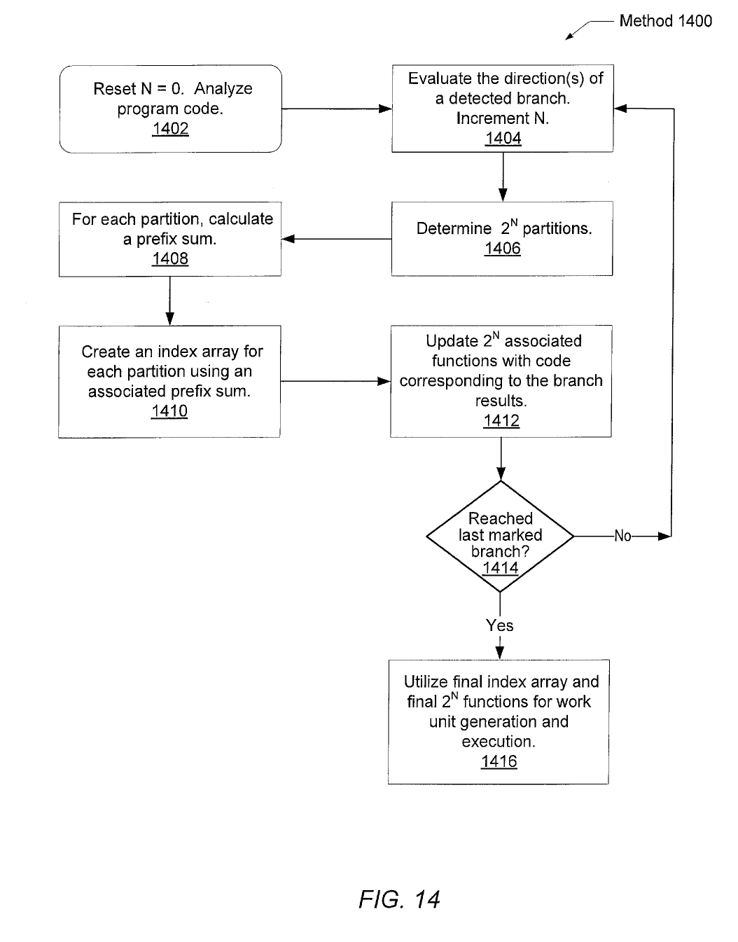

As shuffling of data in memory may include copying large amounts of data, an alternative method includes creating an index array and accessing the data via the index array. Referring now to FIGS. 13 and 14, one embodiment of creating an index array for data access is shown. The method 1400 of FIG. 14 will be explained together with the example shown in FIG. 13. In this example, eight records of data have record identifiers (IDs) 1302 of 0 to 7 for ease of illustration. These record IDs and corresponding data may be stored in a records array.

In block 1402, an index N may be reset to 0 and the code of a given compute kernel may be analyzed. The index N may maintain a count of branch instructions. In block 1404, a direction of a detected branch instruction may be evaluated. For a given conditional statement in a compute kernel, the branch results 1304 are as shown, wherein a binary 1 indicates “Taken/Pass” and a binary “0” indicates “Not-Taken/Fail”. In other examples, the indications of the binary values may be switched. A conditional statement in the compute kernel code may include an “EvaluateFunction” as shown in code 230 in FIG. 3. The conditional “EvaluateFunction” may be invoked on each record to generate a bitmap indicating the associated directions of the branch for each record. The “EvaluateFunction” may return a binary index that may be used to determine a direction (“Taken”, “Not-Taken”) of a given branch depending on the data in a given record. The branch results 1304 may be stored in a mask array. In block 1406, a number of partitions may be determined based on the count N. The number of partitions may indicate a number of new compute kernels to generate. Referring again to FIG. 10, for N branches in a compute kernel, there are 2^{N} functions generated.

In one embodiment, in order to efficiently determine a mapping 1320 between work unit IDs 1310 and a created index array 1312 used for actual parallel execution of the work units, a prefix sum technique may be used for parallel processing. Generally speaking, a prefix sum is an operation on lists in which each element in the result list is obtained from the sum of the elements in an operand list up to its index. For example, an input array with n values, {x₀, . . . , xₙ₋₁}, may be used to produce an output array {y₀, y₁, y₂, . . . , yₙ₋₁} where {y₀=x₀, y₁=y₀+x₁, . . . yᵢ=yᵢ₋₁+xᵢ}. This prefix sum 1306 may be stored in a sum array. The prefix sum technique may utilize one or more instructions already supported by a processor. In block 1408, the prefix sum 1306 may be generated from the branch results 1304.

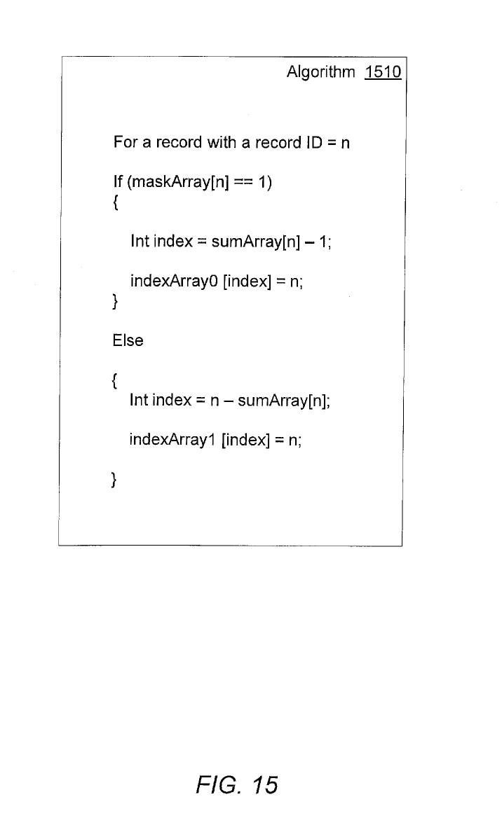

In block 1410, an index array may be determined for each partition found in block 1406. In one embodiment, index arrays may be generated by utilizing the algorithm 1510 as shown in FIG. 15. The algorithm 1510 is further described below. Both index array0 1312 and index array1 1314 may be generated using the algorithm 1510 and the prefix sum 1306. A mapping 1320 may be generated using the work unit IDs 1310 and the index arrays 1312 and 1314. Here, the work unit IDs 1310 have the same values as the record IDs 1302 for ease of illustration. The record IDs 1302 may be originally assigned to the work unit IDs 1310, wherein this assignment is based on sequential locations in memory and sequential increments of an ID pointer. For example, the original records order 1240 may be used. If a last marked branch is reached (conditional block 1414), then in block 1416, the final index arrays and generated functions may be used for scheduling the work units and execution. For example, work unit ID 2 may be associated with a compute kernel with function code corresponding to a Taken Path and the record ID 3. The work unit ID 5 may be associated with a compute kernel with function code corresponding to a Not-Taken Path and the record ID 4. The functions generated from code within a compute kernel due to the branch removal may be referred to as compute sub-kernels.

Referring to FIG. 15, one embodiment of an algorithm 1510 for generating index arrays is shown. In one embodiment, the steps in algorithm 1510 may be used to generate index array0 1312 and index array1 1314 in the example shown in FIG. 13. The branch results 1304 may be stored in the maskArray shown in the algorithm. The prefix sum 1306 may be stored in the sumArray shown in the algorithm.

For each taken branch indicated as a binary “1” in the branch results 1304, the “Then” path of the algorithm 1510 may be executed. Here, an index is set to one less than a prefix sum value associated with a given taken branch and a record that caused the taken direction. An index array associated with a given partition determined in step 1406 of method 1400 is updated with an ID of the taken branch. In one embodiment, the ID is the ID of the record that produced the taken direction of the given branch.

For each not-taken branch indicated as a binary “0” in the branch results 1304, the “Else” path of the algorithm 1510 may be executed. Here, an index is set to the record ID value less the value of a prefix sum value associated with a given taken branch and the record that caused the not-taken direction. An index array associated with a different partition than the partition described above for the “Then” path and determined in step 1406 of method 1400 is updated with an ID of the taken branch. When each of the records is traversed, an associated index array is constructed for each partition.

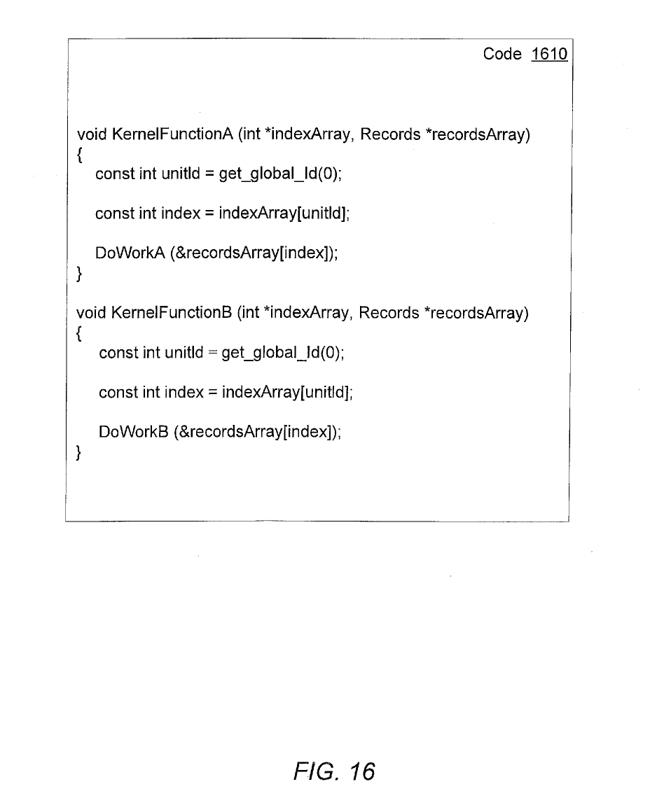

Referring to FIG. 16, one embodiment of source code 1610 defining the compute kernels utilizing the index arrays is shown. In one embodiment, particular branches are marked for evaluation during the index array generation. There may be a large number of branches in a given compute kernel. Rather than perform analysis for each branch, a software programmer, a compiler or another tool may determine which branches are marked for analysis and index array generation. Similar to code 210 and code 230 shown in FIG. 2 and FIG. 3, respectively, the code 1610 includes two function calls entitled “doWorkA” and “doWorkB”. Again, each function call may be referred to as a “compute kernel”. Here, only one of the two compute kernels may be executed during runtime. The IDs of a record array maybe sequentially traversed. However, an index array may be accessed by a given record ID and a mapped value for the record ID is provided. The mapped value may be used to access a given record for execution of the an associated function of the two functions “doWorkA” and “doWorkB”. For example, referring again to FIG. 13, the record IDs 0-3 are mapped by the index array0 1312 to IDs 0, 1, 3 and 6. The associated records are combined with the code used for a path for a taken branch. The record IDs 4-7 are mapped by the index array1 1314 to IDs 2, 4, 5 and 7. The associated records are combined with the code used for a path for a not-taken branch. In the code 1610, these paths may be defined by the code in the functions “doWorkA” and “doWorkB”.

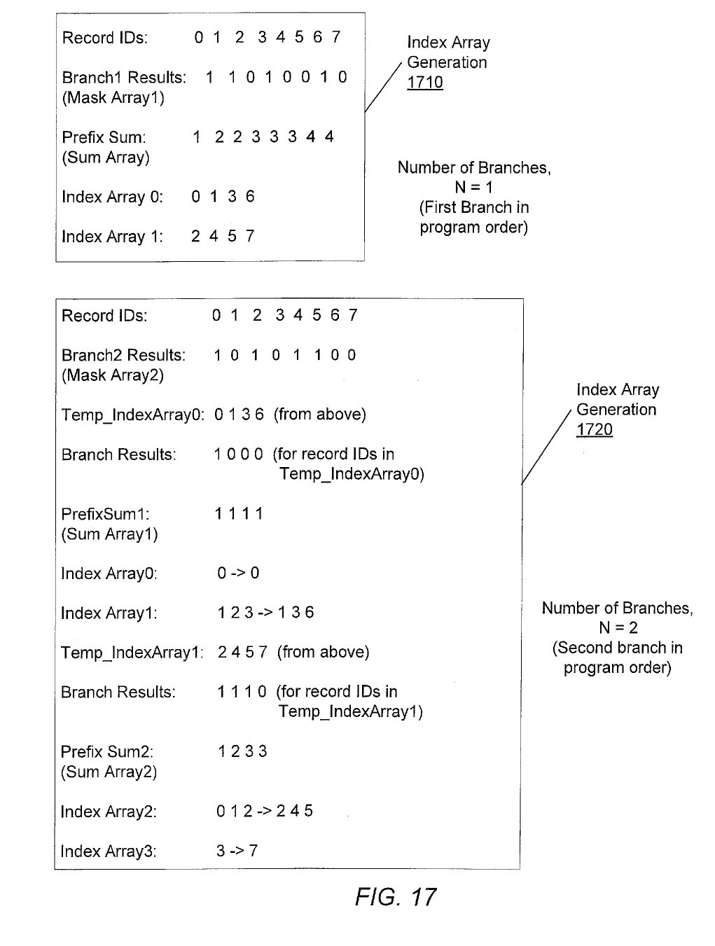

Turning now to FIG. 17, one embodiment of index array generation for two branches is shown. Generation 1710 illustrates the steps previously discussed in FIG. 13 where only one branch was discussed. Generation 1720 expands on the generation 1710 when a second branch instruction is detected in a compute kernel. With two branches, four index arrays are generated. The index array0 corresponds to both branches being taken and includes record ID 0. The index array1 corresponds to the first branch being taken and the second branch being not-taken. The index array1 includes record IDs 1, 3 and 6. The index array2 corresponds to the first branch being not-taken and the second branch being taken. The index array2 includes record IDs 2, 4 and 5. Finally, the index array3 corresponds to both branches being not-taken. The index array3 includes record ID 7.

With index array generation and subsequent remapping of the access of records of data during execution, the computation units within a work group are enabled without reshuffling data in memory. Some processors may contain a prefix sum instruction that can be used to accelerate the generation process. In such an embodiment, the data is not reshuffled back into an original order once the computation is complete. However, in some embodiments the generated index arrays may be used to reshuffle the data in memory and after execution of the compute kernels and compute sub-kernels, the index arrays may be used to return the data to original locations. The reshuffled data may be more coalesced, or compact, in memory. Coalesced data typically provides better performance on GPUs that may have no, or limited, caching mechanisms. Accordingly, the benefit of increased performance during execution may outweigh the cost of reshuffling records of data in memory. The generated index arrays may be used to rearrange the record data into a different memory layout, such as changing a row-oriented arrangement into a column-oriented arrangement, or vice-versa.

In one embodiment, the compiler may analyze the control flow test decisions of a compute kernel and produces compute sub-kernels as shown above in FIG. 10 to handle more general control flow graphs. The GPU hardware may be enhanced to produce a logical bitmask with Boolean results of the control flow decisions. A local slice (workgroup-sized) is accessible to the compute kernel. At the control flow decision point, a decision bitmask may be processed to produce a set of indices which this set of instances of the compute kernel continues processing. For example, the GPU registers corresponding to the local_Id and global_Id designators may be updated. Essentially, the kernel assumes a new “identity” at this point. If this compute kernel instance contains live data (in registers) that was created dependent on the compute kernel ID, then the compiler may generate code to store this data in memory to be consumed by the proper instance of the compute kernel which assumes this identity. Alternatively, the compiler may elect to terminate the compute kernel and generate a new compute kernel that is invoked at this point, completing the execution.

In another embodiment, an architecture with a low-cost compute kernel dispatch and memory sharing between a CPU and a GPU may have the CPU execute the control flow graph, and have a corresponding compute kernel for each basic block of the control flow graph. The CPU may be in charge of dispatching the proper compute kernels, which do not have control flow, at each decision point in the control flow graph.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Additionally, program instructions may comprise behavioral-level description or register-transfer level (RTL) descriptions of the hardware functionality in a high level programming language such as C, or a design language (HDL) such as Verilog, VHDL, or database format such as GDS II stream format (GDSII). In some cases the description may be read by a synthesis tool which may synthesize the description to produce a netlist comprising a list of gates from a synthesis library. The netlist comprises a set of gates which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the instructions on the computer accessible storage medium may be the netlist (with or without the synthesis library) or the data set, as desired. Additionally, the instructions may be utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer implemented method comprising:
identifying a branch instruction in a compute kernel within a computer program;
generating a plurality of compute sub-kernels, each corresponding to a unique outcome of the branch and comprising code from the compute kernel; and
producing a plurality of work units by assigning one or more records of data corresponding to a given outcome of the branch to one of the plurality of compute sub-kernels corresponding to the given outcome.

2. The method as recited in claim 1, further comprising removing the branch from a compiled version of the computer program.

3. The method as recited in claim 1, further comprising scheduling the sub-kernels for execution on at least one of a first processor core or a second processor core.

4. The method as recited in claim 1, wherein assigning said one or more records of data comprises moving said one or more records of data to a same location in a memory for sequential or stride based access.

5. The method as recited in claim 1, wherein assigning said one or more records of data comprises remapping access from originally assigned sequential records to said one or more records.

6. The method as recited in claim 5, wherein remapping for each of the plurality of compute sub-kernels is done in a parallel manner.

7. The method as recited in claim 1, further comprising utilizing prefix sums based on branch outcomes to remap access from originally assigned sequential records to said one or more records.

8. The method as recited in claim 7, wherein the second processor core is a graphics processing unit configured to compute the prefix sum.

9. A computing system including a multi-core architecture comprising:
a processor; and
a memory storing program instructions;
wherein the program instructions are executable by the processor to:
analyze a computer program;
identify a branch instruction in a compute kernel within a computer program;
evaluate the branch with a given record of data to determine an outcome;
generate a plurality of compute sub-kernels, each comprising code from the compute kernel corresponding to a unique outcome of the branch; and
produce a plurality of work units to be invoked in the compiled computer program by assigning one or more records of data corresponding to a given outcome of the branch to one of the plurality of compute sub-kernels associated with the given outcome.

10. The computing system as recited in claim 9, wherein the program instructions are further executable to remove the branch from a compiled version of the computer program.

11. The computing system as recited in claim 9, further comprising scheduling the work units for execution on the processor.

12. The computing system as recited in claim 9, wherein assigning said one or more records of data to said one of the plurality of compute sub-kernels comprises moving said one or more records of data to a same group location in a memory for sequential or stride access.

13. The computing system as recited in claim 9, wherein assigning said one or more records of data to said one of the plurality of compute sub-kernels comprises remapping access from originally assigned sequential records to said one or more records.

14. The computing system as recited in claim 13, wherein remapping for each of the plurality of compute sub-kernels is done in a parallel manner.

15. The computing system as recited in claim 14, wherein the parallel remapping utilizes a prefix sum technique based on branch outcomes.

16. The computing system as recited in claim 9, wherein the second processor core is configured to compute and utilize prefix sums based on branch outcomes to remap access from originally assigned sequential records to said one or more records.

17. A computer readable storage medium storing program instructions, wherein the program instructions are executable to:
identify a branch instruction in a compute kernel within a computer program;
generate a plurality of compute sub-kernels, each corresponding to a unique outcome of the branch and comprising code from the compute kernel; and
produce a plurality of work units by assigning one or more records of data corresponding to a given outcome of the branch to one of the plurality of compute sub-kernels corresponding to the given outcome.

18. The computer readable storage medium as recited in claim 17, wherein the program instructions are further executable to remove the branch from a compiled version of the computer program.

19. The computer readable storage medium as recited in claim 17, wherein assigning said one or more records of data to said one of the plurality of compute sub-kernels comprises moving said one or more records of data to a same group location in a memory for sequential or stride access.

20. The computer readable storage medium as recited in claim 17, wherein the program instructions are further executable to compute and utilize prefix sums based on branch outcomes to remap access from originally assigned sequential records to said one or more records.
